(19) United States
(12) Patent Application Publication
(10) Pub. No.: US 2026/0177112 A1
(43) Pub. Date: Jun. 25, 2026

(54) MULTI DISC PARK BRAKE INTEGRATED INTO A TRANSMISSION

(71) Applicant: ArvinMeritor Technology, LLC, Troy, MI (US)

(72) Inventors: Stephen W. Rumple, Birmingham, MI (US); Kevin Noens, Aurora, NY (US); Jerome M. Kunert, Shelbyville, MI (US); Derek C. Donnelly, Leonard, MI (US)

(21) Appl. No.: 18/999,494

(22) Filed: Dec. 23, 2024

(51) Int. Cl. F16D 55/40

(52) U.S. Cl. CPC F16D 55/40

(57) ABSTRACT

A drivetrain including a motor, a transmission assembly, and a park brake assembly is provided. The transmission assembly includes a main shaft extending along a central longitudinal axis between a first end and a second end and configured to be driven by the motor. The second end configured to be operably coupled to at least one wheel to drive the at least one wheel. The park brake assembly integrated into the transmission assembly and operably coupled to the first end of the main shaft. The park brake assembly configured to apply a park brake torque at the first end of the main shaft to inhibit rotation of the main shaft and the at least one wheel.

### TECHNICAL FIELD

The present disclosure relates to motor vehicles and drivetrains therefor, and more particularly to a park brake integrated into a transmission.

### BACKGROUND

Motor vehicles, such as off-highway motor vehicles, including material handling motor vehicles, such as fork lifts, also referred to as high-lows, are known to have electric powertrains, including electrically driven transmissions providing power to wheels of a drivetrain. In such known motor vehicles, it is further known to incorporate brake assemblies, including spring-applied and hydraulically-released (SAHR) brake assemblies, to provide both service braking and park braking functionality. Although effective to provide the desire braking, these known systems incorporate a separate brake assembly in each wheel to provide the desired braking to the associated wheel. Accordingly, known brake assemblies are costly, complex in design, assembly and coordinated functionality, occupy a large amount of space within each wheel end, and add a large amount of weight to the motor vehicle.

### SUMMARY

According to one embodiment of the present disclosure, a drivetrain including a motor, a transmission assembly, and a park brake assembly is provided. The transmission assembly may include a main shaft configured to be driven by the motor. The main shaft may extend along a central longitudinal axis between a first end and a second end. The second end may be configured to be operably coupled to at least one wheel to drive the at least one wheel. The park brake assembly may be integrated into the transmission assembly and operably coupled to the first end of the main shaft. The park brake assembly may be configured to apply a park brake torque at the first end of the main shaft to inhibit rotation of the main shaft and the at least one wheel.

The second end of the main shaft may be configured to be operably coupled to a differential configured to drive an axle about a differential axis that may be substantially transverse to the central longitudinal axis of the main shaft. The at least one wheel may include a pair of wheels operably coupled to opposite ends of the axle.

According to another embodiment, a powertrain is provided. The powertrain may include an electric motor, a transmission assembly, a differential, an axle, at least one wheel, and a park brake assembly. The transmission assembly may include a main shaft configured to driven by the electric motor and the main shaft may extend along a central longitudinal axis between a first end and a second end and the differential may be operably coupled to the second end of the main shaft. The axle may extend from the differential in a direction substantially transverse to the central longitudinal axis to opposing axle ends and at least one wheel may be coupled to each axle end. The park brake assembly may be operably coupled to the first end of the main shaft and configured to apply a park brake torque at the first end to inhibit rotation of the main shaft, thereby inhibiting rotation of the at least one wheel.

According to yet another embodiment, a method of operating a park brake of a motor vehicle is provided. The motor vehicle may include a park brake assembly, a transmission assembly, and an electric motor that may be operatively disposed therebetween. The method may include coupling a park brake assembly to a main shaft of a transmission. The main shaft of the transmission may include a first end and an opposing second end, and the opposing second end may be coupled to a differential. The method may further include applying a park brake torque to the first end of the main shaft and in response to the applying the park brake torque to the main shaft, inhibiting rotation of the main shaft, thereby inhibiting rotation of the one or more wheels.

### BRIEF DESCRIPTION OF THE DRAWINGS

FIG. 1A is a schematic plan view of a motor vehicle having a powertrain including a transmission with a park brake integrated therein in accordance with an aspect of the disclosure;

FIG. 1B is an isometric view of the transmission with park brake integrated therein in accordance with an aspect of the disclosure; and

FIG. 2 is a cross-sectional view of the transmission of the powertrain taken generally along the line 2-2 of FIG. 1B.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ± 0%, 0.1%, 0.5%, 1%, 2%, 3%, 4%, 5% or 10% of the value or relative characteristic.

When an element or layer is referred to as being "on," "engaged to," "connected to," or "coupled to" another element or layer, it may be directly on, engaged, connected or coupled to the other element or layer, or intervening elements or layers may be present. In contrast, when an element is referred to as being "directly on," "directly engaged to," "directly connected to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). The term "and/or" includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as "inner," "outer," "beneath," "below," "lower," "above," "upper," and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below” or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

As described herein, certain motor vehicles, such as off-highway motor vehicles, including material handling motor vehicles, including fork lifts, also referred to as high-lows, may be powered or driven by electric powertrains, including electrically driven transmissions providing power to wheels of a drivetrain. These vehicles may include spring-applied and hydraulically-released (SAHR) brakes that may employ a spring to apply constant brake force, and hydraulic pressure to release the brakes. SAHR brakes may be used in heavy-duty industrial applications to decelerate inertia loads or park static loads. SAHR brakes may also be used to stop a vehicle if one or more hydraulic components malfunctions. However, SAHR brakes generally require a separate brake assembly apart from the powertrain or drivetrain of the vehicle. Moreover, SAHR brakes are generally costly, complex in design and require a relatively large amount of space at each wheel end.

It is an object of the disclosure to address one or more of the above-mentioned drawbacks with conventional SAHR brakes.

As will be described herein, the present disclosure contemplates a powertrain assembly or drivetrain assembly provided with an integrated park brake that may be disposed within or coupled to a transmission assembly for a motor vehicle.

In accordance with these and objects and other aspects of the disclosure, a drivetrain is provided having a transmission assembly with a park brake assembly integrated therein. The transmission assembly has a main shaft configured to be driven by a motor. The main shaft extends along a central longitudinal axis between a first end and a second end. The second end is configured for operable coupling to at least one wheel to drive the at least one wheel. The park brake assembly is operably coupled to the first end of the main shaft to apply a park brake torque to inhibit rotation of the main shaft, thereby inhibiting rotation of the at least one wheel.

In accordance with another aspect of the disclosure, the second end of the main shaft is configured for operable coupling to a differential. The differential is configured to drive an axle about a differential axis extending substantially transverse to the central longitudinal axis of the main shaft, wherein a pair of wheels are operably coupled to opposite ends of the axle.

In accordance with another aspect of the disclosure, a gear train operably coupled to the main shaft between the first end and the second end of the main shaft, the gear train configured to be driven by the motor.

In accordance with another aspect of the disclosure, transmission assembly includes a transmission housing and the park brake assembly includes a park brake housing fixed to the transmission housing, the park brake assembly including a first disc assembly fixed to the first end of the main shaft for conjoint rotation with the main shaft and a second disc assembly coupled to the park brake housing against rotation with the main shaft, the first disc assembly and the second disc assembly being movable into engagement with one another to inhibit rotation of the main shaft about the central longitudinal axis and being moveable out from engagement with one another to allow rotation of the main shaft about the central longitudinal axis.

In accordance with another aspect of the disclosure, an annular seal configured to seal off the park brake assembly from the transmission assembly to inhibit fluid from the transmission assembly from entering the park brake assembly, thereby keeping the first disc assembly and the second disc assembly free from fluid.

In accordance with another aspect of the disclosure, a first biasing member configured to impart a first bias force to move the first disc assembly and the second disc assembly into engagement with one another and a second biasing member configured to impart a second bias force to move the first disc assembly and the second disc assembly out from engagement with one another.

In accordance with another aspect of the disclosure, first biasing member is a spring configured to impart the first bias force and the second biasing member is a hydraulic system configured to impart the second bias force.

In accordance with another aspect of the disclosure, spring is configured to drive a piston under the first bias force axially along the central longitudinal axis in a first direction and the hydraulic system is configured to drive the piston under the second bias force axially along the central longitudinal axis in a second direction opposite the first direction.

In accordance with another aspect of the disclosure, second bias force is greater than the first bias force.

In accordance with another aspect of the disclosure, a powertrain, including: a motor; a transmission assembly having a main shaft configured to be driven by the motor, the main shaft extending along a central longitudinal axis between a first end and a second end; a differential operably coupled to the second end of the main shaft; an axle extending from the differential substantially transversely to the central longitudinal axis of the main shaft to opposite axle ends; at least one wheel coupled to each axle end; and a park brake assembly operably coupled to the main shaft to apply a park brake torque to inhibit rotation of the main shaft, thereby inhibiting rotation of the at least one wheel.

In accordance with another aspect of the disclosure, a method of inhibiting wheels of a motor vehicle from rotating, comprising:

In accordance with another aspect of the disclosure, the method can further include coupling a park brake assembly to a main shaft of a transmission of the motor vehicle and configuring the park brake to apply a park brake torque to the main shaft to inhibit rotation of the main shaft, thereby inhibiting rotation of the wheels.

In accordance with another aspect of the disclosure, the method can further include coupling the park brake to a first end of the main shaft and coupling a differential to an opposite second end of the main shaft.

The method can further include providing the park brake having a spring applied and hydraulically released actuator.

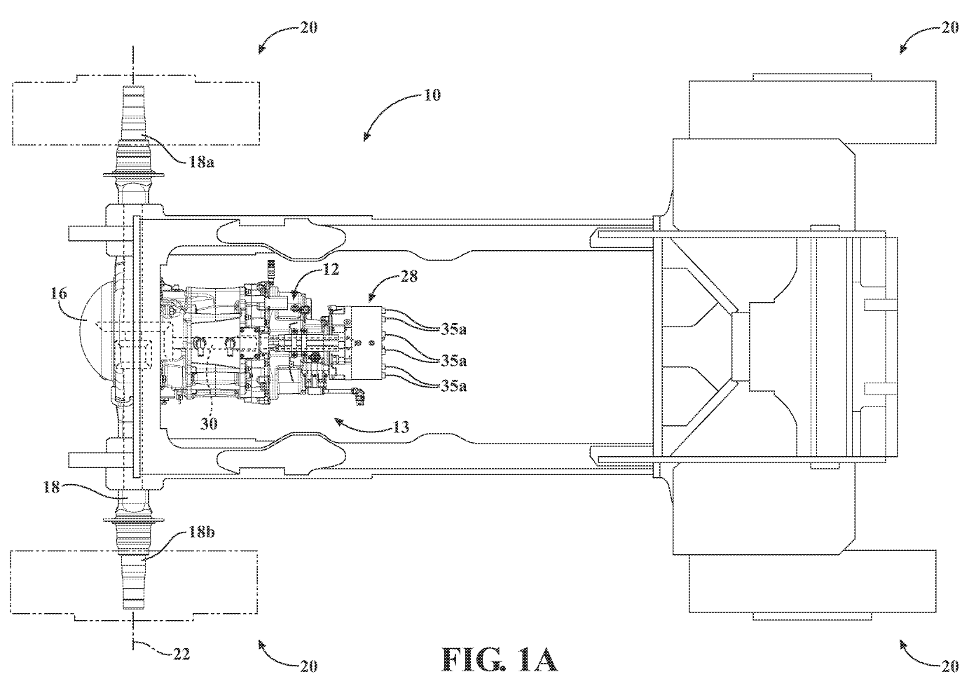

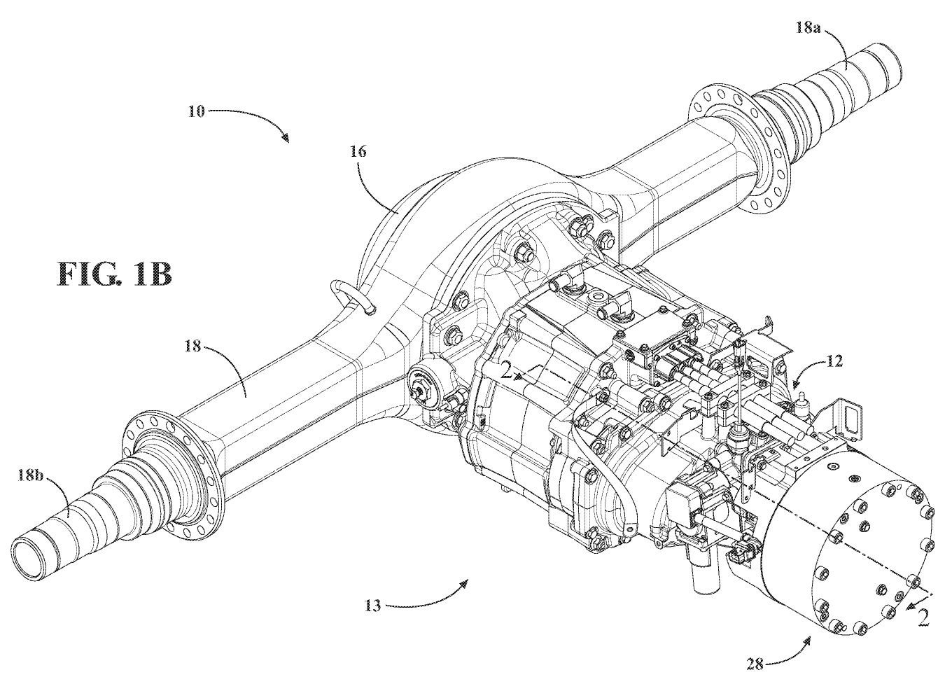

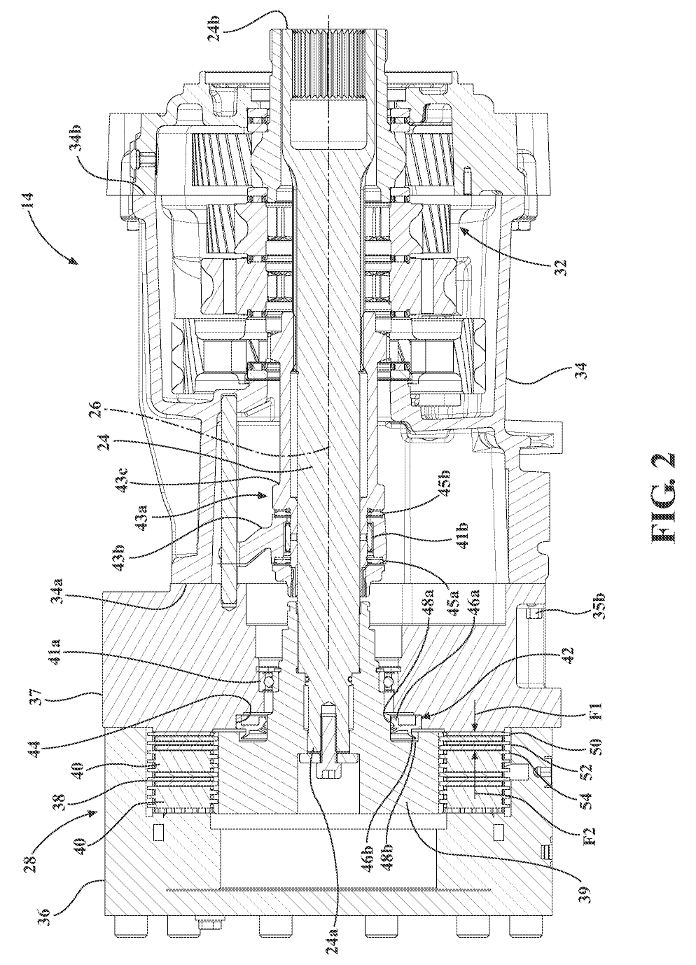

In FIG. 1A, a powertrain 10 of a motor vehicle is illustrated. Powertrain 10 includes a motor 12 configured to drive a drivetrain 13 including a transmission assembly 14 (FIGS. 1A-2) and a differential 16 operably coupled to the transmission assembly 14, with an axle 18 extending from the differential 16 to opposite axle ends 18a, 18b. At least one wheel 20 is coupled to each axle end 18a, 18b for driven rotation about an axle axis, also referred to as differential axis 22, in response to motor 12 driving a main shaft 24 (FIG. 2) of the transmission assembly 14 to rotate about a central longitudinal axis 26. The main shaft 24 extends along the central longitudinal axis 26 between a first end 24a and a second end 24b, wherein the differential 16 is operably coupled to the second end 24b. The central longitudinal axis 26 and the axle axis 22 extend substantially transversely to one another.

A park brake assembly 28 is integrated into the transmission assembly 14 via being operably coupled to the main shaft 24 to apply a park brake torque to inhibit rotation of the main shaft 24, thereby inhibiting rotation of the wheels 20, and thus, acting to maintain the motor vehicle in a parked, stationary state. The motor vehicle, in accordance with a non-limiting aspect of the disclosure, can be a non-highway motor vehicle, such as an off-road vehicle, including a material mover, such as a fork lift, also referred to as a high-low, or other type of material handling motor vehicle.

In the illustrated embodiment, the motor 12 is an electrically powered motor configured to drive the main shaft 24 rotatably about the central longitudinal axis 26 via a gear train 32 operably coupled to the main shaft 24 between the first end 24a and the second end 24b of the main shaft 24. The second end 24b of the main shaft 24 is coupled to the differential 16 by a pinion shaft 30. The pinion shaft 30 is configured to drive a ring gear of the differential 16, with the ring gear configured to drive a planetary gear set, by way of example and without limitation, to drive the axle 18 rotatably about the axle axis 22, thereby causing wheels 20 to be rotatably driven during powered movement of the motor vehicle. When desired to prevent unwanted movement of the motor vehicle, such as when parked on an incline, by way of example and without limitation, park brake assembly 28 is applied to prevent rotation of the main shaft 24 of the transmission assembly 14, which in turn prevents rotational movement of the pinion 30, thereby preventing rotation of the axle 18 and wheels 20.

While the illustrated embodiment, the shows the motor 12 disposed between the park brake and the differential 16, it is contemplated herein that the differential 16 may be disposed between the motor 12 and the park brake assembly 28.

The transmission assembly 14 includes a case, also referred to as transmission housing 34 having a first end 34a and a second end 34b, and a park brake housing 36 operably fixed to the first end 34a of transmission housing 34, shown as being fixed to park brake housing 36 via an intermediate adaptor housing 37, by way of example and without limitation. Transmission housing 34 is fixed to adaptor housing 37 via a plurality of fasteners, such as bolts 35a, by way of example and without limitation, and park brake housing 36 is fixed to adaptor housing 37 via a plurality of fasteners, such as bolts 35b, by way of example and without limitation. As such, transmission housing 34, park brake housing 36, and adaptor housing 37 are fixed against relative movement with one another and remain stationary in application.

Main shaft 24 is supported for rotation about central longitudinal axis 26 by at least one radial bearing, shown as including a first radial ball bearing 41a having an outer race supported by adaptor housing 37 and an inner race supported by a main body, also referred to as driver 39. Further, a second radial needle bearing 41b is housed in a shift collar 43b of a clutch collar assembly 43a, with needles of the needle bearing 41b running on an outer surface of a clutch collar 43c of the clutch collar assembly 43a. Main shaft 24 is further supported in a thrust direction, parallel to central longitudinal axis 26, by at least one, and shown as a pair of thrust needle bearings 45a, 45b. The main shaft 24 extends through the first end 34a and the second end 34b of transmission housing 34, with the main shaft 24 shown extending beyond the first end 34a for coupling to the brake assembly 28 and beyond the second end 34b for coupling to the pinion shaft 30.

The park brake assembly 28 has a disc pack, including a first disc assembly 38 fixed to the first end 24a of the main shaft 24 via driver 39, for conjoint rotation with the main shaft 24, and a second disc assembly 40 coupled to the park brake housing 36 in static relation therewith, such that the second disc assembly 40 is fixed stationary and against rotation with the main shaft 24 as the main shaft 24 rotates. The first disc assembly 38 and the second disc assembly 40 are interleaved with one another and are movable into frictional engagement with one another to inhibit relative rotation between the first disc assembly 38 and the second disc assembly 40, thereby inhibiting rotation of the main shaft 24 about the central longitudinal axis 26, placing motor vehicle in a stationary park state. The first disc assembly 38 and the second disc assembly 40 are movable out of substantial frictional engagement with one another to allow rotation of the main shaft 24 about the central longitudinal axis 26 when desired to move motor vehicle via driven action of wheels 20 by motor 12.

An annular seal 42 is configured to seal off the park brake assembly 28 from the transmission assembly 14 to inhibit fluid from the transmission assembly 14 from entering the park brake assembly 28, thereby keeping the first disc assembly 38 and the second disc assembly 40 in a dry environment, free from fluid. In the illustrated embodiment, annular seal 42 is fixed in stationary relation on an annular shoulder 44 of adaptor housing 37, with one or more seal lips configured for sealing engagement with a surface of the driver 39, shown as including seal lip(s) 46a configured for sealing engagement with an axially extending surface 48a of driver 39 and seal lip(s) 46b configured for sealing engagement with a radially extending surface 48b of driver 39. It is contemplated that the annular seal could be configured to rotate with main shaft 24 and driver 39, with the seal lips being reversed to engage transmission housing 34, if desired. Accordingly, park brake assembly 28 operates as a “dry” brake assembly, thereby reducing frictional losses, such as can result from the presence of fluid via cavitation losses.

A first biasing member 50, such as a spring, e.g. Bellville or coil spring, by way of example and without limitation, is configured to impart a first bias force F1 directed along an axial direction parallel to the central longitudinal axis 26 to move the first disc assembly 38 and the second disc assembly 40 into braking engagement with one another. During braking engagement of the first disc assembly 38 and the second disc assembly 40 with one another, the main shaft 24 is inhibited from rotating, and thus, the wheels 20 are maintained in stationary, parked relation with a ground surface. Further, a second biasing member 52, such as a hydraulic system, by way of example and without limitation, is configured to impart a second bias force F2 opposite the first bias force F1 to move the first disc assembly 38 and the second disc assembly 40 out from braking engagement with one another.

While the first disc assembly 38 and the second disc assembly 40 are moved out from braking engagement with one another, the main shaft 24 is free to rotate, and thus, the wheels 20 are able to roll along the ground surface, such as under the power of motor 12, by way of example and without limitation. The spring 50 is configured to drive a piston 54 under the first bias force F1 axially along the central longitudinal axis 26 in the first direction and the hydraulic system 52 is configured to drive the piston 54 under the second bias force F2 axially along the central longitudinal axis 26 in the second direction opposite the first direction, wherein the second bias force F2 is greater than the first bias force F1.

Park brake assembly 28 may be economical in design, assembly, and use by permitting a single park brake assembly 28 to place the motor vehicle in a park brake state, whereat the main shaft 24 of the transmission assembly 14 is inhibited from rotating, even under torque load applied thereto, such as while motor vehicle is resting on an inclined surface and applying a torque force through the differential 16 and pinion shaft 30.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A transmission assembly comprising:
a main shaft configured to be driven by a motor, wherein the main shaft extends along a central longitudinal axis between a first end and a second end, wherein the second end is configured to be operably coupled to at least one wheel to drive the at least one wheel; and
a park brake assembly integrated into the transmission assembly and operably coupled to the first end of the main shaft, wherein the park brake assembly is configured to apply a park brake torque at the first end to inhibit rotation of the main shaft and the at least one wheel.

2. The transmission assembly of claim 1, wherein the second end of the main shaft is configured to be operably coupled to a differential configured to drive an axle about a differential axis extending substantially transverse to the central longitudinal axis of the main shaft, wherein the at least one wheel includes a pair of wheels operably coupled to opposite ends of the axle.

3. The transmission assembly of claim 2, further comprising:
a gear train operably coupled to the main shaft between the first end and the second end of the main shaft and configured to be driven by the motor, wherein the motor is an electric motor configured to be disposed between the park brake assembly and the transmission assembly.

4. The transmission assembly of claim 1, further comprising:
a transmission housing, wherein the park brake assembly includes a park brake housing fixed to the transmission housing, wherein the park brake assembly further includes a first disc assembly fixed to the first end of the main shaft for conjoint rotation with the main shaft and a second disc assembly coupled to the park brake housing against rotation with the main shaft, the first disc assembly and the second disc assembly being movable into engagement with one another to inhibit rotation of the main shaft about the central longitudinal axis and being moveable out from engagement with one another to allow rotation of the main shaft about the central longitudinal axis.

5. The transmission assembly of claim 4, further including an annular seal configured to seal off the park brake assembly from the transmission assembly to inhibit fluid from the transmission assembly from entering the park brake assembly, thereby keeping the first disc assembly and the second disc assembly free from fluid.

6. The transmission assembly of claim 4, further including a first biasing member configured to impart a first bias force to move the first disc assembly and the second disc assembly into engagement with one another and a second biasing member configured to impart a second bias force to move the first disc assembly and the second disc assembly out from engagement with one another.

7. The transmission assembly of claim 6, wherein the first biasing member is a spring configured to impart the first bias force and the second biasing member is a hydraulic system configured to impart the second bias force.

8. The transmission assembly of claim 7, wherein the spring is configured to drive a piston under the first bias force axially along the central longitudinal axis in a first direction and the hydraulic system is configured to drive the piston under the second bias force axially along the central longitudinal axis in a second direction opposite the first direction.

9. The transmission assembly of claim 8, wherein the second bias force is greater than the first bias force.

10. A powertrain, including:
an electric motor;
a transmission assembly having a main shaft configured to be driven by the electric motor, the main shaft extending along a central longitudinal axis between a first end and a second end;
a differential operably coupled to the second end of the main shaft;
an axle extending from the differential substantially transversely to the central longitudinal axis of the main shaft to opposing axle ends;
at least one wheel coupled to each axle end; and
a park brake assembly operably coupled to the first end of the main shaft and configured to apply a park brake torque at the first end to inhibit rotation of the main shaft, thereby inhibiting rotation of the at least one wheel.

11. The powertrain of claim 10, wherein the park brake assembly is integrated within the transmission assembly.

12. The powertrain of claim 10, further including a gear train operably coupled to the main shaft between the first end and the second end of the main shaft, wherein the gear train is configured to be driven by the motor.

13. The powertrain of claim 12, further comprising:
an adaptor housing,
wherein the transmission assembly includes a transmission housing and the park brake assembly includes a park brake housing wherein the adaptor housing is disposed between and fixed to the park brake housing and the transmission housing,
wherein the park brake assembly includes, a first disc assembly fixed to the first end of the main shaft for conjoint rotation with the main shaft and a second disc assembly coupled to the park brake housing against rotation with the main shaft,
wherein the first disc assembly and the second disc assembly are movable to engage with one another to inhibit rotation of the main shaft about the central longitudinal axis and moveable to disengage from one another to allow rotation of the main shaft about the central longitudinal axis.

14. The powertrain of claim 13, further comprising:
an annular seal fixed to the adaptor housing and configured to seal off the park brake assembly from the transmission assembly to inhibit fluid from the transmission assembly from entering the park brake assembly, thereby keeping the first disc assembly and the second disc assembly free from fluid.

15. The powertrain of claim 13, further including a first biasing member configured to impart a first bias force to move the first disc assembly and the second disc assembly into engagement with one another and a second biasing member configured to impart a second bias force to move the first disc assembly and the second disc assembly out from engagement with one another.

16. The powertrain of claim 15, wherein the first biasing member is a spring configured to impart the first bias force and the second biasing member is a hydraulic system configured to impart the second bias force.

17. The powertrain of claim 15, wherein the second bias force is greater than the first bias force.

18. A method of operating a park brake of a motor vehicle, the motor vehicle including one or more wheels, a park brake assembly, a transmission assembly, and an electric motor operatively disposed therebetween, the method comprising:
coupling the park brake assembly to a main shaft of the transmission assembly, wherein the main shaft of the transmission assembly includes a first end and an opposing second end, wherein the opposing second end is configured to be coupled to a differential;
applying, by the park brake assembly, a park brake torque to the first end of the main shaft; and
in response to applying the park brake torque to the main shaft, inhibiting rotation of the main shaft, thereby inhibiting rotation of the one or more wheels.

19. The method of claim 18, wherein the park brake assembly includes a park brake housing, a first disc assembly, and a second disc assembly,
wherein the coupling step includes moving a first disc assembly so that the first disc assembly engages a second disc assembly, wherein the first disc assembly is fixed to the first end of the main shaft and the second disc assembly is fixed to the park brake housing, wherein the first disc assembly and the second disc assembly are disposed within the park brake housing.

20. The method of claim 19, further comprising:
disengaging the first disc assembly from the second disc assembly by supplying hydraulic fluid between the first disc assembly and the second disc assembly.
